(19) United States
(12) Patent Application Publication
(10) Pub. No.: US 2002/0108860 A1
(43) Pub. Date: Aug. 15, 2002

(54) Fabrication of polymeric microfluidic devices

(76) Inventor: Sau Lan Tang Staats, Hockessin, DE (US)

Correspondence Address: Pamela D. Politis, Ratner & Prestia, P.O. Box 7228, Wilmington, DE, 19803, US

(21) Appl. No.: 10/046,362

(22) Filed: Jan. 14, 2002

Related U.S. Application Data
(60) Provisional application No. 60/261,581, filed on Jan. 15, 2001.
(60) Provisional application No. 60/261,584, filed on Jan. 15, 2001.

(51) Int. Cl. C02F 1/40; C02F 11/00; C25B 9/00; C25B 11/00; C25B 13/00; B29C 70/68

(52) U.S. Cl. 204/601; 264/259

(57) ABSTRACT

Devices containing microfluidic features suitable for use as microfluidic devices or as masters for replicating polymeric microfluidic devices are provided. The devices provide unique design features provided by ink-jet fabrication methods.

This application claims priority to U.S. Provisional Patent application No. 60/261,581 filed Jan. 15, 2001 and U.S. Provisional Patent application No. 60/261,584 filed Jan. 15, 2001.

### FIELD OF THE INVENTION

This invention relates to ink-jet fabrication methods for microfluidic devices, and ink-jet fabrication methods for injection molding masters for mass-producing microfluidic devices.

### BACKGROUND OF THE INVENTION

A microfluidic, or lab-on-a-chip (LOC), device is a planar device, one surface of which contains some of the following microfluidic features: intersecting channels, reservoirs, valves, flow switches, etc., which are fabricated using semiconductor microfabrication technology. The device surface is typically sealed with another planar surface so that the channels are enclosed except at samples injection points. Microfluidic devices are designed for complex laboratory functions such as DNA sequencing, analytical separation and measurements. The first of such devices disclosed in the patent literature was made of silicon as disclosed by Pace in U. S. Pat. No. 4,908,112.

Microfluidic devices are considered the enabling technology for low cost, high versatility operations, many of which find great utility in biotech and pharmaceutical industries. Microfluidics implies the use of microfabrication technology to create enclosed channels, generally interconnected in a planar geometry, where fluids are transported by means of electrical energy or pressure.

Applications of planar microfabricated devices primarily include using electroosmotic, electrokinetic, and/or pressure-driven motions of liquids and particles for fluid transport. The proceedings of the Micro Total Analysis Systems-2000 Symposium (A. Van Den Berg and W. Olthuis, ed., Kluwer Academic Publishers, Dortrecht (2000)) highlight the recent rapid progress in the field of microfluidics.

In liquid phase applications, especially in capillary electrophoresis, the channel widths used by those skilled in the art are generally uniform in width with the most common width at about 100 μm or smaller.

The prevailing method for manufacturing commercially available microfluidic devices comprises of the following sequence of steps:

1) Spincoating a layer of photoresist on a substrate, typically a piece of flat Pyrex® glass with or without a layer of chrome.

2) Fabricating a photomask with the desired microfluidic design with methods known in the art.

3) Imprinting the desired microfluidic design on the photoresist by exposing the photoresist coating to light through the photomask with the design on it.

4) Develop the photoresist coating so that the locations for microfluidic features on the glass will be bare, and the rest of the glass will be under the coating.

5)Direct etching of the exposed areas with acids such as hydrofluoric acid (HF) so that channels, reservoirs, etc., will be formed by the acid removal of the glass.

On other substrates such as silicon, methods such as deep reactive ion etching (DRIE) can be used to make deep channels. This method of microfabrication using photolithography and chemical etching is generally carried out in clean room facilities specifically designed for semiconductor microfabrications.

FIG. 1 shows a schematic of a conventional microfluidic device formed on a substrate 8, with channels 4 and fluid reservoirs 6. These types of devices, especially if the channels are deep, are typically formed through a process illustrated in FIG. 2. The substrate 8 has an etch-resistant material 202 positioned on top of the substrate surface, and layers of various materials are deposited over the substrate. As shown in FIG. 2, there is a planarizing layer 204, a barrier layer 206 and a resist layer 210 all separately deposited over the substrate to form the device. A mask is used to expose the resist layer of the device to radiation, and then the resist is developed 212 and removed according to the mask exposure. This is followed by a reactive ion etch step 214 to etch the barrier later according to the mask exposure, and then another reactive ion etch step 216 to etch the planarizing layer. Multiple deposition, lithography and etch steps are required to form the channels 218 by the conventional method.

Polymer devices may also be fabricated by methods such as injection molding, casting and hot embossing. These methods require the use of a mold, or a master which is used to replicate as many microfluidic devices as needed. For making molds for plastic devices through casting, injection molding and hot-embossing, the microfluidic features in the master are the ‘negative’ of the desired features in the final polymeric devices, i.e., channels in the final polymer devices 110 are raised ‘ridges’ in the mold or master. To make such a mold, the steps described above are carried out on a substrate such as silicon. The silicon substrate is then electroplated over with a metal to form a metallic ‘negative’ of the microfluidic features. The silicon substrate is then dissolved away. The remaining metallic mold becomes the master.

### SUMMARY OF THE INVENTION

The present invention provides a microfluidic device comprising a substrate and a channel on the substrate. The channel comprises a side wall, and a polymeric material forms the side wall. The side wall is formed by depositing a plurality of microdroplets of polymeric material from a nozzle. The channel may also have a cover formed of the polymeric material or an overhang structure formed of the polymeric material.

The microfluidic device provided may be an injection-molding master that is a positive or negative representation of a resultant microfluidic device.

Also provided is a process of making microfluidic devices. The process comprises emitting microdroplets of a polymeric material from a nozzle onto a substrate; and forming a pattern of microfluidic device features on the substrate from the polymeric material emitted from the nozzle. This process may include emitting the microdroplets of the polymeric material from an ink-jet printer.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1: A schematic representation of a top view of a conventional microfluidic device formed by a process using photolithographic masking and chemical etching.

FIG. 2: A schematic representation of a conventional microfabrication process to make channels with high depth to width aspect ratios using photo-mask and etching technology.

FIGS. 3A, 3B and 3C: A schematic representation of a fabrication process of an overhang structure in a microfluidic device with two different jet-resist materials.

FIG. 4 shows a schematic representation of a method for achieving microfluidic features using ink-jet print techniques with multiple passes of the printhead over the same substrate according to the present invention.

FIGS. 5-10 show a schematic of a process of microfluidic device fabrication according to the present invention.

FIG. 11 shows a schematic representation of a process disclosed according to the invention of fabricating an enclosed microfluidic channel on a single substrate.

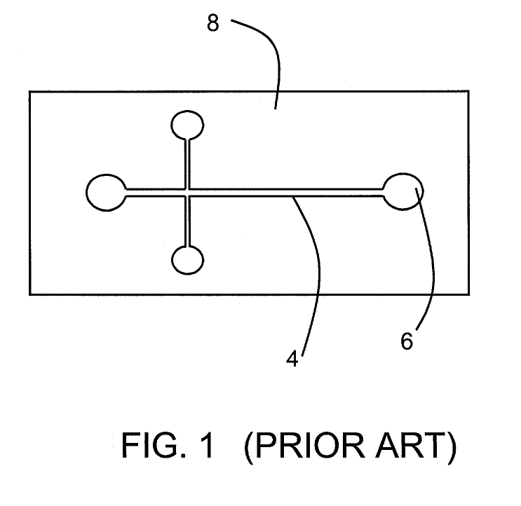

### DETAILED DESCRIPTION OF THE INVENTION

In this disclosure, ink-jet printing technology provides the fabrication method for fabricating the desired microfluidic features directly on a substrate such as glass, ceramics, silicon, polymers or any organic, inorganic or hybrid organic-inorganic materials that form a flat surface for the printing of features. Moreover, the disclosed methods are suitable for creating a device with negative microfluidic features that may be used as a master for low-cost replicating of multiple copies of the desired microfluidic devices on polymeric substrates of choice by injection molding, compression molding, hot-embossing and casting of polymers, and for creating microfluidic devices that do that require an additional substrate to enclose the microfluidic channels residing on the first substrate.

In U.S. Pat. No. 6074725, it was disclosed that the walls of the microfluidic channels in a microfluidic device are built from liquid polymer deposited from a print head drop by drop. The resulting microfluidic channels were open channels that required another substrate to be bonded to the walls of the channels as a cover.

The process according to the present invention provides for a covered channel formed by the same material as the channel walls, wherein the channel cover is formed over the channel without requiring another substrate to be bonded over the channel. In additional to the covered channel feature, the microfluidic devices presented can also include an overhang structure that may be used as a valve in microfluidic devices, in addition to other utilities.

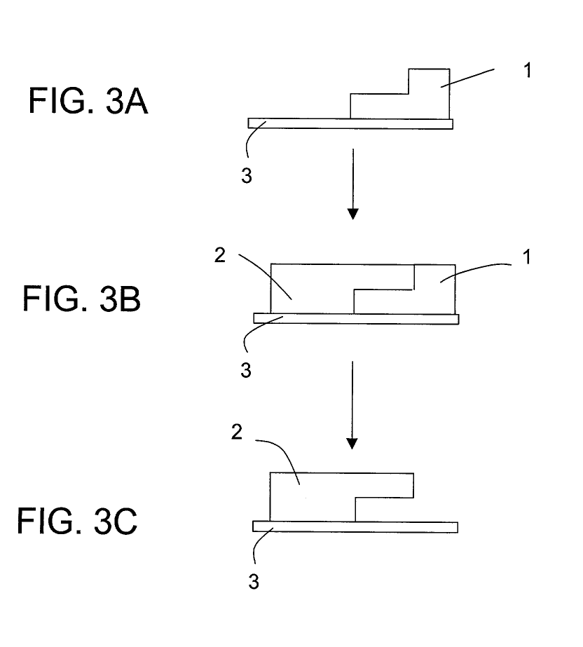

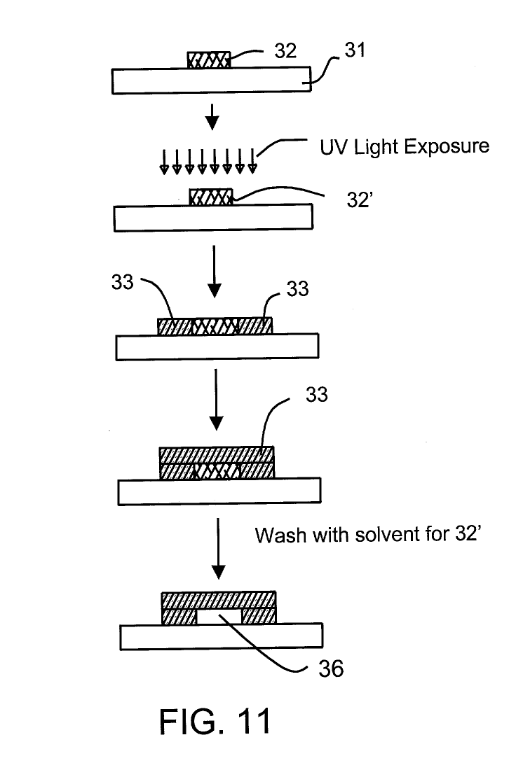

The covered channel is shown in FIGS. 10 and 11 as feature 20 and 36 respectively. The overhang structure is illustrated in FIG. 3C. These unique design features for microfluidic devices may be formed easily by printing the devices with ink-jet printing technology. The fabrication of these features is set forth in the figures.

According to one embodiment of this invention, a process of making a microfluidic device may include emitting microdroplets of a polymeric material from an ink-jet printing nozzle onto a substrate and creating a pattern of microfluidic device features on the substrate from the polymeric material. The polymeric material may be a solution or suspension, also referred to herein as ‘jet-resist’. The emitted microdroplets are from a source or reservoir of jet-resist materials. The jet-resist materials may contain inorganic or organic particles, including corn starch, in the polymer solution or suspension.

This pattern may be the desired device pattern, or the negative of the device pattern. A direct ink-jet pattern would be desired if the device is intended to be used directly as a functional microfluidic device, or as the master for an electroplated mold. The negative of the desired microfluidic features is “printed” onto the substrate if the device is to be used as a mold itself for microfluidic devices. Regardless of the nature of the feature pattern, the polymeric jet-resist material is cured after deposition by the ink-jet device.

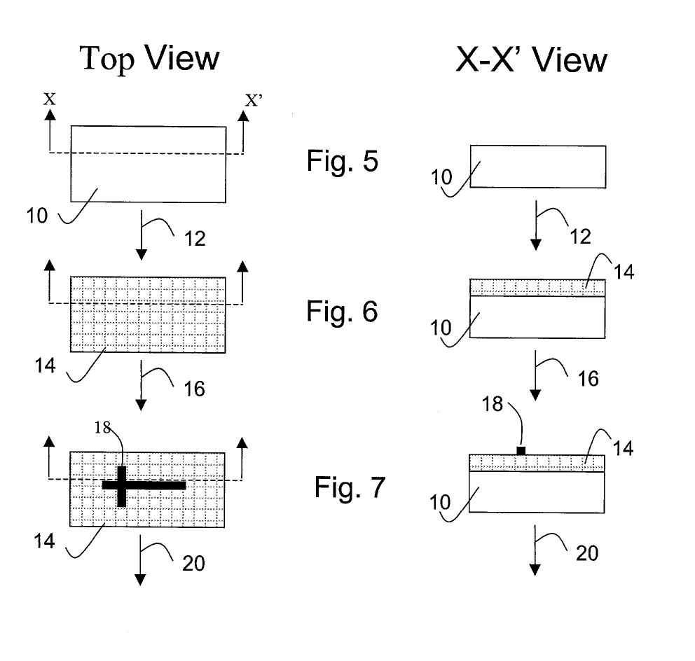

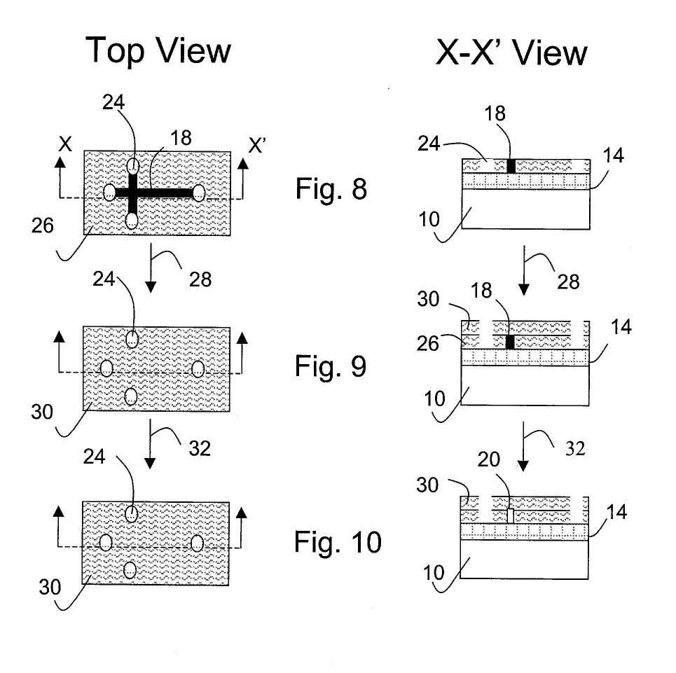

The maskless formation of channels and reservoir features of a microfluidic device is illustrated sequentially in FIGS. 5-10. Each of these figures provide a top view of the device and a sectional view along the X-X′ line. A substrate 10 is shown in FIG. 5, and the uniform deposition 12 of a polymeric material 14 over the substrate is shown in FIG. 6. A sacrificial material 18 is then printed 16 onto the layer 14, as shown in FIG. 7. The printed feature 18 is shown as a channel configuration, including intersecting channels. Printing 20 of another layer of polymeric material 26 is done such that the sacrificial material pattern 18 is surrounded, except in areas where a reservoir 24 is desired, typically at the ends of channels, as shown in FIG. 8. To form a covered channel without using another substrate as a cover, another layer may be deposited 28. FIG. 9 shows another layer of polymeric material, 30 printed over the layer containing the sacrificial material. The sacrificial material can be removed 32 by washing the device in a solvent that dissolves the sacrificial material, but does not dissolve the other polymeric material of the device. Also, the sacrificial material may be removed by exposing the printed sacrificial material to radiation prior to printing a cover layer. This allows the sacrificial material to be removed upon exposure to developer. This method is shown schematically in FIG. 11. A substrate 31 is printed with an area of sacrificial material 32. The device is then exposed to UV radiation with causes the sacrificial material 32′ to be soluble in developer. A polymeric material 33 is then printed around the exposed sacrificial material 32′, and another layer of polymeric material is then printed over the sacrificial material. The device is then washed in a developer solvent and the exposed sacrificial material is washed out of the device, forming a buried void feature, such as a channel 36.

For this embodiment of the present invention, a photo-sensitive polymer is used as a jet-resist. The smallest dimensions of the structure 32 are determined by the instrument's printhead resolution. Structural dimensions as small as 100 μm are possible with currently available devices. After curing the polymer, the structure is exposed to ultraviolet light according to conditions appropriate for this photosensitive polymer. The ultraviolet light causes the photosensitive polymer to decompose such that the structure 32 becomes 32′, which has the same physical shape as structure 32, but is more soluble in an appropriate solvent than structure 32. Then additional structures, 33,are deposited of the same jet-resist polymer onto the substrate on both side of the structure 32′, and then a second layer is deposited on top of the first layer after appropriate curing of the first layer. After curing, the two layers of structures are washed with the appropriate solvent. The exposed layer 32′, which has been rendered more soluble in this solvent because of the UV light exposure, is washed away and the enclosed channel results. Microfluidic features such as reservoirs may also be deposited by the printhead to the open ends of the enclosed channel to form a conventional microfluidic channel of a width of about 100 μm or higher, and a depth of 10 to 50 μm. Likewise multiple layers with multiple internal channels, reservoirs and other microfluidic features may be fabricated. No photomasks are needed.

By printing material only where it is necessary in the microfluidic device design, this ink-jet fabrication method eliminates the need for costly photolithography and etching steps in forming the intricate features of these devices. To create a void in a conventional device, a mask is typically used to expose a sacrificial material that is removed and then a reactive ion etching or and solvent development step is performed to remove the material where a void, such as a channel or reservoir is desired.

In addition to forming buried features, sacrificial materials can be used to form unique devices that cannot be formed through conventional lithography methods used in microfluidic devices in the art. FIG. 3a-3c illustrate the fabrication of one such device, an overhang structure, also referred to as a hinged structure. A substrate 3 is shown in FIG. 3A with a sacrificial material structure 1 that has been printed in the shape of an “L.” A polymeric material is printed over the sacrificial material 1 to form an “L” in the opposite orientation, as shown in FIG. 3B. The sacrificial material is then removed, leaving the polymeric material 2 in a open overhang orientation, shown in FIG. 3C.

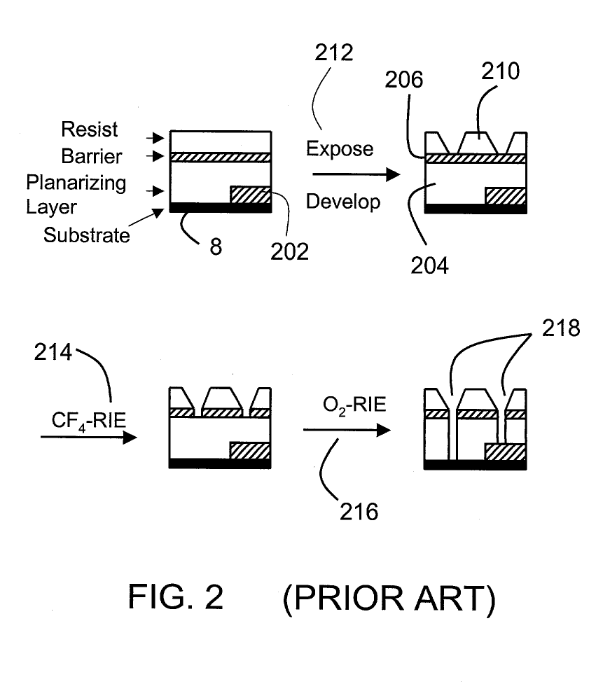

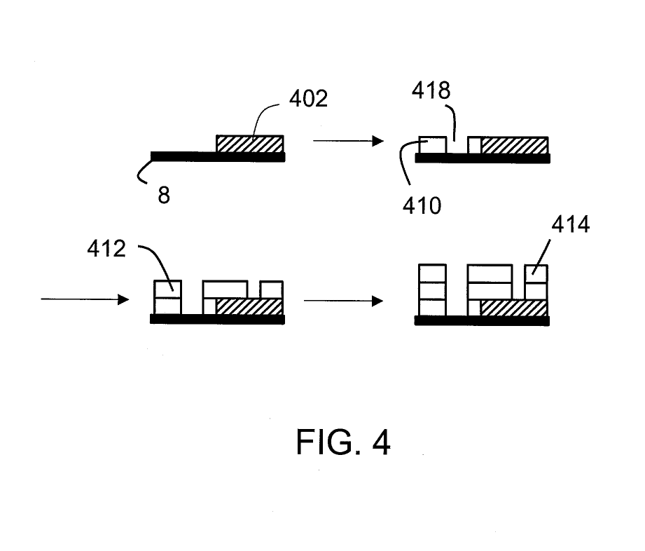

As shown in FIG. 4, sacrificial materials are not necessary to form features such as channels by the technology of the present invention. Either a single or multiple-pass printing of the same structures using ink-jet printing methods can form microfluidic device features. A substrate 8 has a first material 402 deposited over it, and a jet-resist or polymeric material is printed 410 onto the substrate such that a void area 418 is provided. The surface of the printed jet-resist material may be optimized by curing and surface modification methods before the next layer of jet-resist 412 is deposited. Another layer 414 may be deposited to form microfluidic device features that have similar dimensions as the device shown in FIG. 2, formed via multiple etching steps.

In one embodiment of the invention, the chemical composition of the microdroplets may be different from one pass of the ink-jet nozzle to the next. In one particular instance of this embodiment, the surface tensions of the microdroplets may be manipulated so as to optimize the final shape of the multilayered structures created by making multiple passes of the nozzle or nozzles emitting microdroplets of different compositions. The surface of the substrate, or the surface of the dried microdroplets may be modified chemically by acids, bases and other chemical surface modifiers, and/or physico-chemically by surface plasma treatment.

In another instance of this embodiment, the chemical compositions of the jet-resists from one pass of the printhead to the next pass over the same substrate in a multiple pass operation may be different in their solubilities in a particular solvent. Differences in solubilities may be used to remove sacrificial materials as well. Another embodiment of the invention provides heating a substrate to aid the evaporation of the solvent from the microdroplets once they are deposited onto the substrate.

Polymers suitable for this process are the photoresists used in conventional photolithography exemplied by PMMA and PMMA copolymers, polybutene-sulfone (PBS), sulfone-novolac systems and the like. Photoresists which become cross-linked and less soluble in a given solvent may also be used. Su-8, an IBM product, may also be used. Conventional developers and methods for developing these resists may be adapted in the ink-jet method described here. A combination of the different photoresists may be used appropriately to achieve complex three-dimensional microfluidic features without the use of any photomasks by one skilled in the art according to this disclosure.

In one embodiment of the invention, the nozzle can be stationary, and the substrate is mounted on a translational stage for the substrate to be moved in two or three orthogonal directions. The process is much the same as the one described above to produce the master.

In another embodiment of the invention, the negative of the final microfluidic device can be directly drawn on the substrate. The microfluidic channels and other depressed features in the final microfluidic device are formed as raised features in this embodiment. A master formed this way is suitable for casting polymers that do not involve high temperature (higher than 100° C.) curing. This mold or a master can be used for replicating microfluidic devices using polymer materials.

Polymers suitable for injection molding with a master formed by directly printing onto a substrate are Topas®, a polyethylene-polycyclic olefin co-polymer sold by Ticona. Alternatively, polymethylmethacrylate (PMMA) can be used, or polycarbonate, polystyrene, or ionomers such as Surlyn® and Bynel® (DuPont Co.) can also be used. The device can be used as a master to make replicas through compression molding with the above polymers and also with Teflon AF® (DuPont Co.). The master can also be used for casting polymer devices with any polymers that can be polymerized inside the mold with polymer precursors and a catalyst. Polymers suitable for casting with this master are PMMA, polymethylbutyllactone, Polydimethylsilonxane (PDMS) and its derivatives, polyurethane, and other castable polymers.

A microfluidic device according to this invention may be used in to make an electroformed master for replicating the microfluidic devices at higher temperatures. A polymer-based mold may be electroformed to obtain a metallic negative replica of the polymer-based mold. Metallic molds are appropriate for injection-molding polymers that require the mold to be heated. The commonly used metal for electroforming is nickel, although other metals may also be used. The metallic electroformed mold is preferably polished to a high degree of finish, or “mirror” finish before use as the mold for injection mold. This finish is comparable to the finish obtained with mechanical polishing of submicron to micron size abrasives. Electropolishing and other forms of polishing may also be used to obtain the same degree of finish. Additionally, the metallic mold surfaces should preferably be as flat and as parallel as the Si, glass, quartz, or sapphire wafers.

When a pattern has been drawn on the substrate, and the microfluidic features have been cured so that there is no deformation of the features by solvents or temperatures under 100° C., the substrate may be electroplated so that a metallic replica of the microfluidic features are made in a negative impression.

In a negative metallic replica, the channels are embodied as ridges, and other trough-like features are raised as well. Common metals for electroplating include copper and nickel, but any metal suitable for plating may be used.

A master device can be used to make replicas through compression molding with the above polymers and also Teflon AF®. A master can also be used for casting polymer devices with any polymers that can be polymerized inside the mold with polymer precursors and a catalyst. Polymers suitable for casting with a master are PMMA, polymethylbutyllactone, PDMS and its derivatives, polyurethane, and other castable polymers.

In order to determine materials appropriate for use in ink-jet devices for fabricating microfluidic devices or models for injection molding used in fabrication of microfluidic devices, low-cost, efficient screening procedures are provided herein.

Since ink-jet formation of microfluidic devices is not conventional, materials designed for lithography and photolithography fabrication methods may or may not be suitable. However, many readily available materials are appropriate materials for ink-jet fabrication. Specific appropriate materials are listed above. Additionally, provided herein is a screening method to evaluate the appropriateness of materials for use in ink-jet fabrication applications. A variety of materials may be screened, including but not limited to:

1) Traditional photoresists such as Su-8, an epoxy-based resists with properties especially suitable for high-aspect ratio multilayered structures;

2) Traditional polymer ink-jet ink materials;

3) Fast drying and curing materials such as polyurethane;

4) Liquid crystalline polymer materials such as hydroxypropylcellulose.

5) Suspensions such as nanometer-scale particles of silicon oxide as exemplified by Ludox® (DuPont Co.) in a polymer solution.

To effectively screen through large groups of materials for a desired combination of properties, this invention discloses the use a “high-throughput” method of screening. The screen will produce pseudo-quantitative data for each candidate concerning the properties of interest.

Properties of interest in materials in ink-jet lithographic applications include:

droplet formation or “jet” properties;

interfacial properties between the droplets and the substrate;

interfacial properties between layers of droplets; and

drying and curing properties of the droplets.

Microdroplet forming may be screened based on the similarity of a test material and a standard ink-jet material with well-established droplet forming properties. This comparison may be effectively achieved through viscosity analysis.

To measure the viscosity of a solution a small round sphere may be dropped into a tube containing a pre-measured height of the test material. The time necessary for the sphere to reach a pre-determined depth indicates the viscosity of the test material as compared to a standard control material, such as a standard ink for ink-jet printers.

For high throughput screening, tubes containing test materials may be put in a array pattern, either grid-like or linear, to facilitate parallel operations. A preferred grid-like pattern conforms to the spacing of sample locations in a 96-well microtiter plate, i.e., 9 mm from center to center.

To evaluate the interfacial properties between a substrate and microdroplets of a test material, a wetting analysis may be used.

A conventional technique for elucidating the wetting properties of a liquid and a solid surface is contact-angle measurement. Contact-angle measurements, however, are slow and expensive to carry out. Disclosed herein is a relatively high throughput method to obtain pseudo-quantitative wetting measurement which may be as follows:

A droplet of known volume of the test material is dispersed with a micropippette, and placed on a clean, leveled substrate of interest. A digital camera mounted directly above the droplet can be used to photograph the droplet so that the size of the droplet is digitally analyzed. A droplet that covers a larger area of the substrate in principle wets the substrate more than the ones that cover smaller areas. A droplet size vs. time study also screens for drying characteristics.

A screen to evaluate interfacial properties between microdroplets and underlying layers of jet-resist material is essentially the same as that disclosed above except that the substrate has been previously covered by a spin-coated overlayer of the test material. This same screen can also be used for interfacial properties of dissimilar test materials.

The screens may also include surfaces that are chemically and/or physically modified. Chemical surface modifications may include washes with acids, bases or siloxane-based modifiers. Physical modifications may include surface plasma treatments.

A piezo-driven ink-jet printer has advantages including flexible software for printing sequences and tunable parameters for the material properties of the jet-resists. For a piezo-driven printer, the substrates are laid flat rather than scrolled, allowing rigid substrate materials, such as glass, ceramics, and thermoset plastics to be used. Detailed measurements of contact angles, viscosity and curing properties may also be carried out, as well as heating of the substrate to improve curing.

The screening may be done iteratively by incorporating analysis of initial screen results into subsequent screening tests. An arrangement of samples in a grid or linear format conforming to the microtiter plate dimensions allows for automation of steps in a screen process. Robotics for liquid dispensing and sample handling may significantly increase the number of candidates that may be screened, and efficiently screen materials for specific applications.

### EXAMPLES

### Example 1

A microfluidic device consisting of channels whose widths are larger than 350 μm and deeper than 5 μm were drawn with a commercially available ink-jet printer with resolution of 2400 dpi×2400 dpi or better. The ink in the ink-jet printer is replaced with a polymer solution with viscosity adjusted to be the same as the inks originally in the commercial ink cartridges. The resolution of the features drawn this way is about 10 μm or better.

### Example 2

A microfluidic device consisting of channels whose widths are larger than 350 μm and deeper than 5 μm were drawn with a commercially available ink-jet printer with resolution of better than 2400 dpi×2400 dpi. The ink-jet printer head contains more than one jet nozzles. Each jet nozzle is linked to a reservoir containing polymer solutions that are different in such a way that after deposition and curing, the polymer forming underlying layers will be dissolved in a solvent, leaving lithographic features that may form cavities, overhang, etc. The viscosity, surface tension and solvent dissolubility of the polymer materials were optimized to give the best resolution and utility to the lithographic features. The devices so drawn were electroplated with a metal such as nickel. The resulting nickel device had features that were the opposite sense of the device as drawn. The nickel device may be used as the mold for injection molding, hot embossing, compression molding and casting. The resolution of the features in the devices after the molding, hot embossing, compression molding and casting were 10 μm or better.

### Example 3

Screens for viscosity and surface tension of the following materials were created according to the present invention:

1) traditional photoresists: epoxy-based resists such as Su-8, Novolac-based resists, polyimide-based polymers, and PMMA-based polymers;

2) traditional polymer ink-jet ink materials;

3) fast drying and curing materials such as polyurethane; and

4) liquid crystalline polymer materials such as hydroxypropylcellulose which may have induced order during ink-jet printing to produce fine resolution.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. A microfluidic device comprising:
A) a substrate and
B) a channel on the substrate, the channel comprising a side wall, wherein the side wall comprises a polymeric material, the side wall is formed by deposition of a plurality of microdroplets comprising the polymeric material from a nozzle.

2. The microfluidic device of claim 1 wherein the channel further comprises a cover comprising the polymeric material.

3. The microfluidic device of claim 1 wherein the channel also comprises a bottom comprising the polymeric material.

4. The microfluidic device of claim 1 wherein the device further comprises an overhang structure comprising the polymeric material, wherein the overhang structure comprises a base positioned over the substrate and an extension extending from an end of the base opposite the substrate, the extension being substantially parallel to the substrate.

5. The microfluidic device of claim 1 wherein the microdroplets of the polymeric material comprise a polymer solution, a polymer suspension, or a combination thereof.

6. An injection molding master for fabricating a molded microfluidic device, the master comprising:
A) a substrate and
B) a channel on the substrate, the channel comprising a side wall, wherein the side wall comprises a polymeric material, the side wall is formed by deposition of a plurality of microdroplets comprising the polymeric material from a nozzle.

7. The master of claim 6 wherein the master reflects a positive representation of the molded microfluidic device.

8. The master of claim 6 wherein the master reflects a negative representation of the molded microfluidic device.

9. A process of making a pattern of microfluidic device features on a substrate, the process comprising:
forming said pattern by emitting microdroplets of a polymeric material from a nozzle onto the substrate to form a deposited pattern on the substrate.

10. The process of claim 9 wherein the pattern of microfluidic device features on said substrate forms an injection molding master for producing a molded microfluidic device, and the process further comprises:
curing the polymeric material forming said deposited pattern to form the injection molding master.

11. The process of claim 10 wherein the deposited pattern is a positive representation of the molded microfluidic device.

12. The process of claim 11 further comprising electroforming a metal onto the injection molding master to form a metallic mold.

13. The process of claim 10 wherein said deposited pattern is a negative representation of the molded microfluidic device.

14. The process of claim 9 wherein emitting the microdroplets of polymeric material is performed by an ink-jet printer.

15. The process of claim 9 wherein the substrate is mounted on a translation device, wherein the translation device moves the substrate to form the pattern of microfluidic features from the microdroplets of polymeric materials emitted from the nozzle.

16. The process of claim 9 comprising forming an overhang structure in the pattern of microfluidic features, forming the overhang structure comprises forming a base positioned over the substrate and an extension extending from an end of the base opposite the substrate, the extension being substantially parallel to the substrate.

17. The process of claim 9 comprising forming a channel in the pattern of microfluidic features.

18. The process of claim 17 comprising forming a channel bottom, a channel sidewall and a channel cover.

19. The process of 18 wherein the sidewall and the cover are formed from the same polymeric material.

20. The process of claim 19 wherein the bottom, the sidewall and the cover are formed from the same polymeric material.

21. The process of claim 9 wherein forming the deposited pattern comprises depositing the microdroplets of polymeric material in a first area and depositing microdroplets of a second polymeric material from the nozzle in a second area of the substrate.

22. The process of claim 21 wherein the deposited microdroplets of polymeric material in the first area and the second polymeric material comprise the same polymeric material.

23. The process of claim 21 wherein the microdroplets of polymeric material deposited in the first area are not soluble in a solvent that solubilizes the second polymeric material.

24. The process of claim 21 further comprising a step removing the first polymeric material.

25. A microfluidic device comprising a device substrate and a channel, wherein the channel comprises a bottom and a sidewall, said device formed by
A) preparing an injection molding mmaster, wherein preparing the injection molding master comprises forming a negative impression of the channel by emitting microdroplets of a polymeric material onto a injection molding master substrate;
B) injecting a second polymeric material into the injection molding master;
C) curing the second polymeric material to form the microfluidic device; and
D) removing the microfluidic device from the injection molding model.
